(19) United States
(12) Patent Application Publication
(10) Pub. No.: US 2014/0011170 A1
(43) Pub. Date: Jan. 9, 2014

(54) Controlling Flow and Pressure Waveforms

(71) Applicants: Troy D. Nickel, Minneapolis, MN (US); Aaron M. Owens, Plymouth, MN (US); David Louis Dingmann, St. Paul, MN (US); Matthew D. Graen, Champlin, MN (US); Andrew D. White, Minneapolis, MN (US)

(72) Inventors: Troy D. Nickel, Minneapolis, MN (US); Aaron M. Owens, Plymouth, MN (US); David Louis Dingmann, St. Paul, MN (US); Matthew D. Graen, Champlin, MN (US); Andrew D. White, Minneapolis, MN (US)

(21) Appl. No.: 13/540,938

(22) Filed: Jul. 3, 2012

(51) Int. Cl. G09B 23/30; F17D 1/00

(52) U.S. Cl. 434/268; 137/565.01; 137/1

(57) ABSTRACT

An apparatus for controlling fluid flow characteristics includes a fluid conduit for containing a fluid, a first dynamic pump connected to a first portion of the conduit, a second dynamic pump connected to a second portion of the conduit and a controller for operating the first and second dynamic pumps to control dynamic flow of the fluid and dynamic pressure in the fluid in the conduit.

### BACKGROUND

This disclosure relates to controlling flow and pressure waveforms in a fluid.

U.S. Pat. No. 7,587,949, incorporated here by reference, discloses a multi-sample biologic material stimulation and characterization system that includes individual flow paths for each sample. Each individual flow path can maintain sterile conditions and may be chemically monitored. The mean flow rate and pulsatile flow rate through each sample may be individually controlled. Pressure at the sample is controlled independently of the flow rate through downstream variable flow restrictors. An axial force may be applied to each sample. A radial force may be applied via hydrostatic pressure of chamber fluid surrounding each sample. A real-time controller manages the system and saves information gathered from the transducers and actuators of the system.

### SUMMARY

In one aspect, an apparatus for controlling fluid flow characteristics includes a fluid conduit for containing a fluid, a first dynamic pump connected to a first portion of the conduit, a second dynamic pump connected to a second portion of the conduit and a controller for operating the first and second dynamic pumps to control dynamic flow of the fluid and dynamic pressure in the fluid in the conduit.

Embodiments may include one or more of the following features. The first and second dynamic pumps are operated to control dynamic flow of the fluid and dynamic pressure in the fluid at a certain position along the conduit. The first dynamic pump is controlled to primarily control the dynamic flow of the fluid, and the second dynamic pump is controlled to primarily control the dynamic pressure in the fluid. One of the pumps is located upstream of the other pump. Each pump is selected from the group of pumps having dynamic capabilities and consisting of (i) a linear actuator with a flexible membrane, (ii) a linear actuator with a bellows, (iii) a positive displacement pump, and (iv) a gear pump. The first and second dynamic pumps are controlled together to control the dynamic flow of the fluid, and the first and second dynamic pumps are controlled together to control the dynamic pressure in the fluid. The conduit is capable of containing a sample that will undergo one or more of (a) measurement to characterize one or more mechanical, biological, electrical and chemical properties of the sample, and (b) mechanical stimulation to cause a change in the sample's characteristics. The conduit itself is being tested. The apparatus further includes a mean flow device for enabling a mean flow of the fluid. The fluid is a liquid. The conduit is flexible. The conduit is capable of containing a bioprothesis. The conduit is capable of containing one or more of a valve and a restrictor. Pressure can be measured upstream and downstream of a sample in the conduit, and pressure at the sample can be estimated from the upstream and downstream pressure measurements. Pressure can be measured at a location in the conduit where a sample is located.

In another aspect, a method for controlling fluid flow characteristics includes pumping a fluid through a conduit with a first dynamic pump that is connected to a first portion of the conduit. The fluid is pumped through the conduit with a second dynamic pump that is connected to a second portion of the conduit. The first and second dynamic pumps are operated with a controller to control dynamic flow of the fluid and dynamic pressure in the fluid in the conduit.

In another aspect, an apparatus for simulating pulsatile fluid flow of blood in a human body includes a fluid conduit for containing a liquid, a first dynamic pump connected to a first portion of the conduit, and a second dynamic pump connected to a second portion of the conduit. A controller operates the first and second dynamic pumps to control dynamic flow of the liquid and dynamic pressure in the liquid in the conduit. Pulsatile flow characteristics can be simulated for various locations in a human circulatory system.

Other features and advantages will be apparent from the description and the claims.

### BRIEF DESCRIPTION OF THE DRAWINGS

FIG. 1 is a schematic view of an apparatus for controlling fluid flow characteristics; and

FIG. 2 is a diagram showing pressures and flows over time at various locations in the human circulatory system;

### DESCRIPTION

To allow individual control of the coupled parameters of flow and pressure in a simulated vascular, or similar, physiological environment, a pair of actuators (e.g. dynamic pumps) are coupled to the system. In one example, a real-time control system actively drives one of the actuators to introduce a desired flow waveform to one side of a sample in the system. At the same time, the control system actively drives the other actuator to control the pressure on the opposite side of the sample. The controlled pressure may be used to apply a targeted pressure waveform at the sample, independently of the desired flow waveform. Depending on the control scheme, each dynamic pump may operate as an instantaneous flow source or flow resistance.

In some examples, the control system uses flow as the primary feedback for the first actuator and uses pressure as the primary feedback for the second actuator. The control system compensates for the effects of flow and pressure on each other to allow independent control of the flow and pressure waveforms. In some examples, the controller is effectively a multi-input/multi-output (MIMO) controller providing a more optimum control distribution between the two dynamic pumps to yield the desired two dynamic outputs. In other examples, a control mode can be used that substantially uses the sum of the two dynamic pumps to create pressure and the difference between the two dynamic pumps to create flow. This will substantially become a MIMO controller where the multiple Inputs are the two pumps and the multiple outputs are pressure and flow. In some examples, a controlled restrictor valve, as described in U.S. Pat. No. 7,587,949, is added to automatically control the mean pressure in the system independently of the flow waveform.

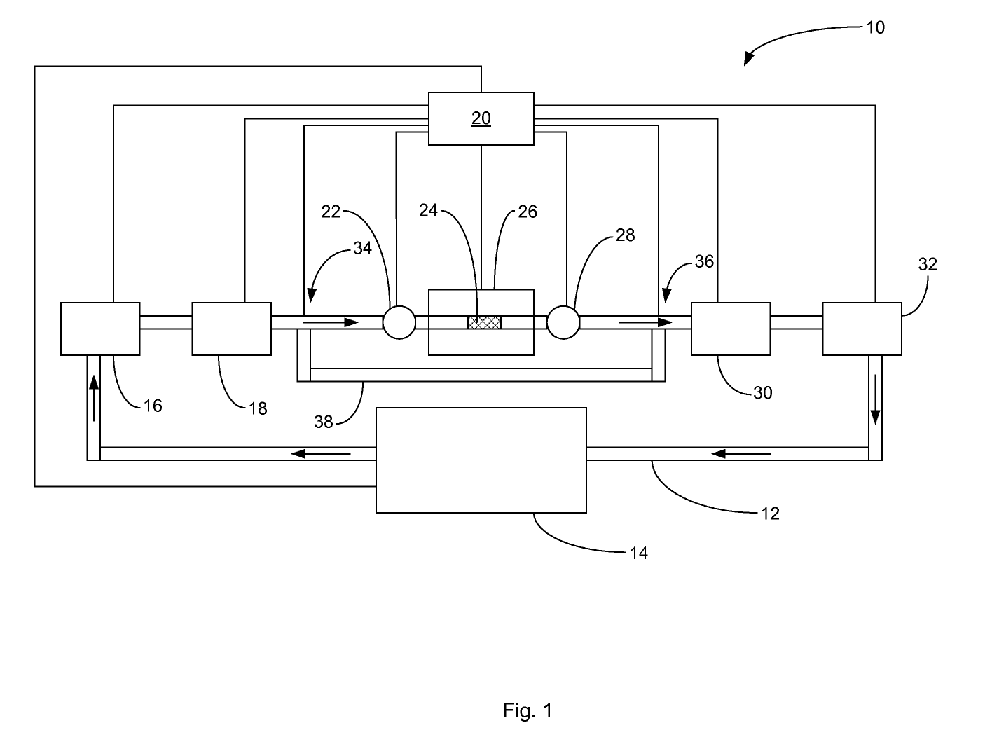

With reference to FIG. 1, an apparatus 10 for controlling fluid flow characteristics includes a fluid conduit 12 for containing a fluid. The conduit 12 can be, for example, tubing, a chamber, or a plenum (all flexible or rigid). The fluid in this example is a liquid (a substantially incompressible fluid) as opposed to a gas (a compressible fluid). A series of arrows in FIG. 1 indicate the direction of flow of the fluid in this example. A reservoir 14 contains a supply of fluid for use in the apparatus 10. The reservoir 14 may include a gas exchanger for degassing the fluid or incorporating gas molecules into the fluid. A mean flow source 16 is used to provide a mean (i.e. steady) flow to the fluid through the apparatus 10. The mean flow source 16 can be (a) an open loop or closed loop gear pump (if the latter a sensor is included on an upstream or downstream sensor pod which is discussed below), (b) a high pressure source with a restrictive valve, or (c) any positive displacement pump or variable pump with feedback.

A dynamic pump 18 is connected to a portion of the conduit 12 and is used to control a pulsatile (i.e. dynamic or variable) flow of the fluid and/or a dynamic pressure in the fluid. The dynamic pump 18 can be, for example, a bellows operated by a linear electromagnetic motor, or a diaphragm driven by a hydraulic actuator. Alternatively, the dynamic pump 18 can be, for example, a dynamic piston (e.g. dual) pump, or a servo gear pump (either capable of controlling both dynamic and mean flow/pressure in the fluid, so in this case the mean flow source 16 can be eliminated). A controller 20 is used to control operation of the reservoir 14 (e.g. resupplying fluid, gassing, degassing, temperature), the mean flow source 16, the dynamic pump 18, and other components in the apparatus 10 (discussed further below). An upstream sensor pod 22 has one or more sensors for measuring characteristics (e.g. flow, pressure, temperature) at that location in the conduit 12. The sensor pod 22 provides feedback on flow characteristics (e.g. mean flow, dynamic flow, mean pressure, dynamic pressure, temperature) to the controller 20. In an alternative arrangement, the sensor pod 22 can be simplified or eliminated, and some characteristics of the fluid flow can be calculated by looking at operating conditions of the mean flow source 16 and/or dynamic pump 18. For example, the dynamic flow rate can be determined by multiplying the linear velocity of the pump times the effective area of the pump head, and the mean flow rate can be determined by the rotational velocity of the gear pump.

A sample to be tested and/or grown 24 is located inside of the conduit 12. The sample 24 may be, for example, a bioprothesis such as a stent, a stented-valve, or valve, or the sample may be, for example, ligament, tendon, skin, cartilage, bone, or a tubular biologic sample such as a vessel with or without a valve, urethra, bladder or trachea. In the stent or stented-valve examples, at least the near-sample portion of the conduit 12 at the sample location is flexible. The sample 24 can include living and/or dead biological tissue, one or more man-made materials, and/or a combination of any of these categories of matter. If the sample 24 includes living tissue, the sample can be grown while in the conduit to form, for example, part or all of a coronary valve. Mechanical stimulus can be applied to the sample to cause a change in the sample's characteristics (e.g. causing the sample to grow). The sample 24 can be characterized by measuring one or more of its mechanical properties before, during and/or after it has been placed in the conduit 12. The sample 24 itself can form part of the conduit 12 at the location of the sample 24.

The entire conduit 12 may be flexible. Such flexibility of the conduit 12 can be achieved by using a thermoplastic elastomer to make the conduit 12. Having a flexible conduit 12 enables the conduit to behave more along the lines of a circulatory system (e.g. veins, arteries) in a human or other living creature. The conduit itself may be tested (in this case the sample 24 may not be present), for example, if the conduit might be used as an artificial portion of a circulatory system (e.g. in heart bypass surgery). In other examples, some or all of the conduit is made of a rigid material such as plastic. An optional chamber 26 can be provided around the sample 24. The chamber 26 can be filled with the fluid from the conduit 12 or a separate fluid.

A downstream sensor pod 28 has one or more sensors for measuring flow characteristics (e.g. flow, pressure, temperature) in the conduit 12 downstream from the sample 24. The sensor pod 28 provides feedback on fluid characteristics to the controller 20. A dynamic pump 30 is connected to a portion of the conduit 12 downstream of the sample 24 and is used to control a pulsatile (i.e. dynamic or variable) flow of the fluid and/or a dynamic pressure in the fluid. The dynamic pump 30 can be a device similar to the devices described above for the dynamic pump 18. A mean pressure modifier 32 is used to control the mean pressure of the fluid downstream of the sample 24. The mean pressure modifier 32 can be, for example, a restriction valve (e.g. non-invasive pinch, a tube pincher mechanism similar to a camera shutter, a gate valve or a ball valve) or a gear pump (quasi static or dynamic, the latter of which can control mean and dynamic pressure/flow which would allow the dynamic pump 30 to be eliminated).

Similar to what is stated above towards the end of paragraph 10, the sensor pod 28 can be simplified or eliminated, and some characteristics of the fluid flow can be calculated by looking at operating conditions of the mean pressure modifier 32 and/or dynamic pump 30. Upon exiting the modifier 32, the fluid is returned to the reservoir 14 via the conduit 12. As an alternative to the closed loop system shown, the fluid exiting from the modifier 32 can instead be routed to a used fluid container (not shown). In this case, the fluid is not recirculated and fresh fluid is always provided to the sample 24.

Bypass valves (not shown) at locations 34 and 36 are controlled by the controller 20 to allow none, some or all of the fluid in the conduit 12 to be diverted into a bypass conduit 38. The bypass conduit, if used, can provide a higher speed adjustment of (a) the mean flow of the fluid, or (b) the outputs of one or both of the dynamic pumps 18 and 30.

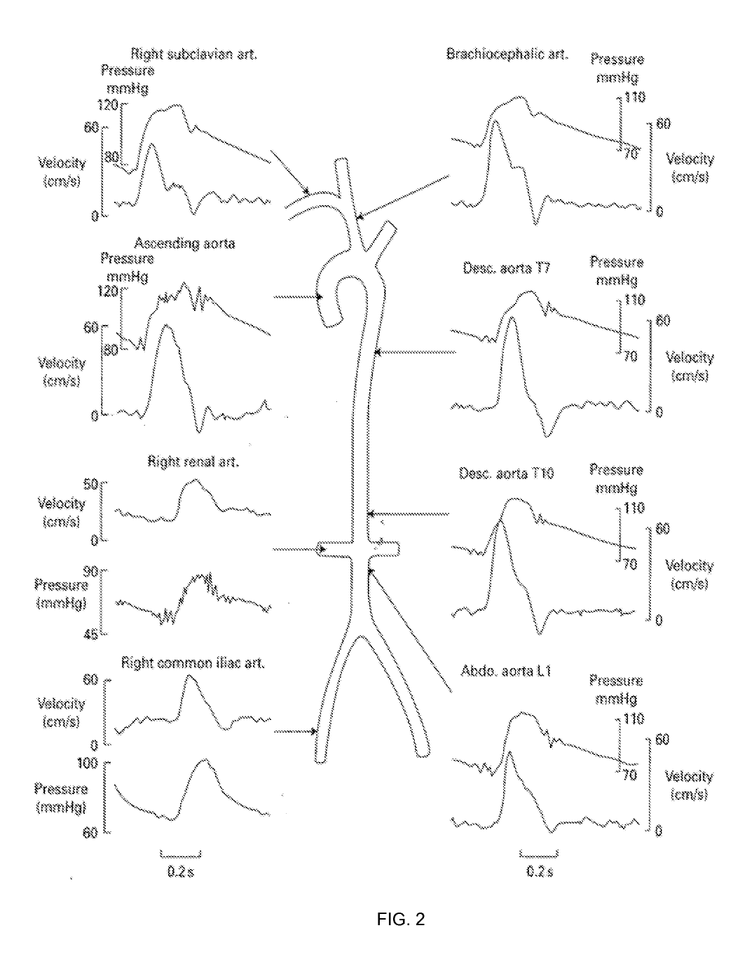

Reference will now be made to FIG. 2. In the human body, the relationship between a flow waveform and the resulting pressure waveform depends on the loading of the downstream circulatory system. FIG. 2 shows pressure and flow levels for a period of time covering about one period of a human heartbeat (at rest) for a number of locations in the human circulatory system where a stent, valve, or other prosthetic may be located. These pressure and flow waveforms are loaded into the controller 20 (FIG. 1). A sample 24 is then loaded into the conduit 12. A user of the apparatus would then operate a user interface (not shown) to select the location in the human circulatory system (e.g. ascending aorta) for which they would like to simulate pressure and flow characteristics. The controller 20 uses feedback from the sensor pods 22 and 28 to operate the dynamic pumps 18 and 30 to control the dynamic flow and dynamic pressure of the fluid in the conduit to achieve the desired flow and pressure waveforms at the location of the sample 24.

Pressure readings from both sensor pods 22 and 28 can be averaged to approximate the pressure at the sample 24. Alternatively, a pressure reading from one of the sensor pods 22 and 28 can be used to calculate the pressure at the sample 24. Likewise, flow readings from both sensor pods 22 and 28 can be averaged to determine the flow at the sample 24. Alternatively, a flow reading from one of the sensor pods 22 and 28 can be used to calculate the flow at the sample 24. The controller 20 can operate (a) the dynamic pump 18 to primarily control the dynamic flow of the fluid, and (b) the dynamic pump 30 to primarily control the dynamic pressure of the fluid. Alternatively, the controller 20 can operate (a) the dynamic pump 18 to primarily control the dynamic pressure of the fluid, and (b) the dynamic pump 30 to primarily control the dynamic flow of the fluid. In another example, the controller can operate both dynamic pumps 18 and 30 to control both the dynamic flow and dynamic pressure in the fluid.

At extreme ends of the control regime, a pulse load can be applied by the dynamic pump 30 in phase with the dynamic pump 18, resulting in flow with no additional net pressure, or the dynamic pumps 18 and 30 can be pulsed out of phase, giving full pressure and minimal flow. This flexibility enables the same system with minimal manual adjustments to be used to control the various flow and pressure waveforms exemplified in FIG. 2. When the tested sample is a heart valve, a non-linearity and/or discontinuities is/are introduced to the system. In this case, an adaptive controller can be used so that the controller can compensate for the non-linearity and accurately control the system.

Other implementations are within the scope of the following claims and other claims to which the applicant may be entitled.

What is claimed is:

1. An apparatus for controlling fluid flow characteristics, comprising:
a fluid conduit for containing a fluid;
a first dynamic pump connected to a first portion of the conduit;
a second dynamic pump connected to a second portion of the conduit; and
a controller for operating the first and second dynamic pumps to control dynamic flow of the fluid and dynamic pressure in the fluid in the conduit.

2. The apparatus of claim 1, wherein the first and second dynamic pumps are operated to control dynamic flow of the fluid and dynamic pressure in the fluid at a certain position along the conduit.

3. The apparatus of claim 1, wherein the first dynamic pump is controlled to primarily control the dynamic flow of the fluid, and the second dynamic pump is controlled to primarily control the dynamic pressure in the fluid.

4. The apparatus of claim 3, wherein one of the pumps is located upstream of the other pump.

5. The apparatus of claim 1, wherein each pump is selected from the group of pumps having dynamic capabilities and consisting of (i) a linear actuator with a flexible membrane, (ii) a linear actuator with a bellows, (iii) a positive displacement pump, and (iv) a gear pump.

6. The apparatus of claim 1, wherein the first and second dynamic pumps are controlled together to control the dynamic flow of the fluid, and the first and second dynamic pumps are controlled together to control the dynamic pressure in the fluid.

7. The apparatus of claim 1, wherein the conduit is capable of containing a sample that will undergo one or more of (a) measurement to characterize one or more mechanical, biological, electrical and chemical properties of the sample, and (b) mechanical stimulation to cause a change in the sample's characteristics.

8. The apparatus of claim 1, wherein the conduit itself is being tested.

9. The apparatus of claim 1, further including a mean flow device for enabling a mean flow of the fluid.

10. The apparatus of claim 1, wherein the fluid is a liquid.

11. The apparatus of claim 1, wherein the conduit is flexible.

12. The apparatus of claim 1, wherein the conduit is capable of containing a bioprothesis.

13. The apparatus of claim 1, wherein the conduit is capable of containing one or more of a valve and a restrictor.

14. The apparatus of claim 1, wherein pressure can be measured upstream and downstream of a sample in the conduit, and pressure at the sample can be estimated from the upstream and downstream pressure measurements.

15. The apparatus of claim 1, wherein pressure can be measured at a location in the conduit where a sample is located.

16. A method for controlling fluid flow characteristics, comprising:
pumping a fluid through a conduit with a first dynamic pump that is connected to a first portion of the conduit;
pumping the fluid through the conduit with a second dynamic pump that is connected to a second portion of the conduit; and
operating the first and second dynamic pumps with a controller to control dynamic flow of the fluid and dynamic pressure in the fluid in the conduit.

17. The method of claim 16, wherein the first and second dynamic pumps are operated to control dynamic flow of the fluid and dynamic pressure in the fluid at a certain position along the conduit.

18. The method of claim 16, wherein the first dynamic pump is controlled to primarily control the dynamic flow of the fluid, and the second dynamic pump is controlled to primarily control the dynamic pressure in the fluid.

19. An apparatus for simulating pulsatile fluid flow of blood in a human body, comprising:
a fluid conduit for containing a liquid;
a first dynamic pump connected to a first portion of the conduit;
a second dynamic pump connected to a second portion of the conduit; and
a controller for operating the first and second dynamic pumps to control dynamic flow of the liquid and dynamic pressure in the liquid in the conduit, whereby pulsatile flow characteristics can be simulated for various locations in a human circulatory system.

20. The apparatus of claim 19, wherein the first dynamic pump is controlled to primarily control the dynamic flow of the liquid, and the second dynamic pump is controlled to primarily control the dynamic pressure in the liquid.

21. The apparatus of claim 19, wherein the second dynamic pump is controlled to primarily control the dynamic flow of the liquid, and the first dynamic pump is controlled to primarily control the dynamic pressure in the liquid.
